(19) United States
(12) Patent Application Publication
(10) Pub. No.: US 2019/0263484 A1
(43) Pub. Date: Aug. 29, 2019

(54) REMOTE CONTROLLED UNMANNED FISHING BOAT

(71) Applicant: Benjamin Michael Wilson, Las Vegas, NV (US)

(72) Inventor: Benjamin Michael Wilson, Las Vegas, NV (US)

(21) Appl. No.: 16/285,249

(22) Filed: Feb. 26, 2019

Related U.S. Application Data
(60) Provisional application No. 62/636,123, filed on Feb. 27, 2018.

(51) Int. Cl. B63B 35/14; G05D 1/02; G05D 1/00; B63B 45/04; A01K 97/12

(52) U.S. Cl. CPC B63B 35/14; G05D 1/0206; G05D 1/0022; B63B 2213/02; B63B 45/04; A01K 97/125; G05D 1/0033

(57) ABSTRACT

The present invention discloses a remote controlled unmanned fishing boat intended to effect remote control fishing. The remote controlled unmanned fishing boat includes a fish shoal detector for detecting a shoal of fish, a first transmitter for transmitting by specific radio waves the information concerning the shoal of fish detected by the fish shoal detector, a propelling power source for propelling the boat, a controller for steering the boat, and a first receiver for receiving specific radio waves concerning the operations of the fish shoal detector, the propelling power source, and the controller, all for inducing the operations. Further, the boat is provided with a lifting handle for lifting the boat from the water surface, wherein the lifting handle is formed from a cutout portion of the boat.

### CROSS-REFERENCE TO RELATED PATENT DOCUMENTS

This patent application claims the benefit of priority of U.S. Provisional Application No. 62/636,123, entitled “REMOTE CONTROLLED UNMANNED FISHING BOAT,” filed February 27, 2018, which are hereby incorporated herein by reference in its entirety.

### FIELD OF THE INVENTION

The present invention relates generally to fishing boat, and, more particularly, to a remote controlled unmanned fishing boat.

### BACKGROUND

Typical casting procedures utilized in fishing arrangements are arranged to project a fishing hook relative to a fishing pole or source of fishing line. Generally, to provide access to remote portions of a lake or the like water bodies, an angler (i.e., a person who fishes with a rod and line) must utilize a boat to traverse the body of water for performing fishing activities in the water body. However, the angler has to roam around the water body for fishing since the angler is not aware of the exact location where the fishes will be most likely located. As a result, significant amount of time and efforts are wasted. So, anglers have long expressed a need to place the fishing line where the fishes are usually located. Many times, the fishes are located in areas that are difficult for the anglers to reach out. Further, the fishes may be beyond casting range for a shore-based angler or in areas surrounded by vegetation or obstructions. These vegetation or obstructions may be above and below the surface of the water. Thus, it may be difficult or impossible to reach such areas using known boats capable of carrying the anglers. In addition, the use of full sized boats, and the engines to power these boats for trolling, creates excessive disturbances in the water which may drive away the fishes from that particular location which is not at all desirable for the anglers.

In many scenarios, a fish finder or sounder is used by the anglers to locate the fishes. The conventional fish finder is constructed by mounting a monitor on a manned fishing boat, attaching a fish finding section to a buoy installed on the water surface, and connecting the depth sounding section or the fish finding section with a wire to the monitor. Such monitors then display a water depth or a shoal of fish in the area surrounding the buoy. In such arrangements, the monitor is connected with a wire to the depth sounding section or the fish finding section. However, using such monitoring arrangements, the angler on the boat may experience difficulty in finding the fishes at the higher depth of water, or the shoal of fish at a place far away from the angler. The buoy has no power of its own, and, therefore, is incapable of moving the depth sounding section or the fish finding section to the required position or the place. Even when the angler is enabled by the monitor to confirm the depth of water or the shoal of fish, it is very difficult for the angler to drop a fishing line at the optimum position by navigating the display on the monitor. Hence, such conventional arrangements for fishing are tedious and time consuming for the anglers.

The prior art discloses numerous types of fishing boats or arrangements that are configured for fishing in the water bodies. One such arrangement is shown in a Chinese patent (CN107114335A) that discloses an intelligent fishing system with a remote-control boat that includes an underwater wireless camera to locate fishes. The intelligent fishing system can quickly find a fishway and throw fond baits of fishes, thereby improving the success rate of fishing. Another Chinese patent (CN103359261B) discloses a three-in-one fishing boat that is used for dragging and detecting fish signals, fishing, and monitoring and controlling the two boats, wherein a remote controller communicates with the dual-body mother boat and the dual-body catcher boat by virtue of wireless signals. The features are similar to the proposed invention. The European patent (EP1602574A1) discloses a remote controlled unmanned boat for underwater surveillance. The remote controlled unmanned boat includes an underwater camera that is capable of determining the object in the water body such as a school of fish. The US patent application (US20170045887) discloses a remote-controlled boat system that includes an underwater camera that can be mounted on a moving stage, wherein the moving stage rotates and moves up and down, so as to obtain numerous different views from a single camera. The US patent (U.S. Pat. No. 6,100,921) discloses a boat with a video camera assembly which is adapted to be mounted in a thru-hull fitting so as to allow for safe and dependable viewing in various environments.

Despite various improvements, the cited patent references do not disclose the stabilization mechanism for capturing less distorted images. Further, the design features of these remote-controlled boats or arrangements are different from the proposed features of the boat of the present invention. In light of the foregoing, there exists a need for an improved and reliable solution that solves the above-mentioned problems and presents a remote controlled unmanned fishing boat with an efficient fish finder.

### BRIEF SUMMARY

It is an objective of the present invention to provide a remote controlled unmanned fishing boat with an efficient fish finder. In an embodiment, the present invention discloses the remote controlled unmanned fishing boat that is intended for using and performing remote control fishing in more efficient and effective manner

In an embodiment, the remote controlled unmanned fishing boat includes a fish shoal detector, a first transmitter, a propelling power source, a controller, a location tracker, a setting device, and a first receiver. The fish shoal detector is configured for detecting a shoal of fish. The first transmitter is configured for transmitting, by specific radio waves, the information concerning the shoal of fish detected by the fish shoal detector. The propelling power source is configured for propelling the remote controlled unmanned fishing boat. The controller is configured for steering the remote controlled unmanned fishing boat. The location tracker is configured for keeping a track of the location of the remote controlled unmanned fishing boat as well as the shoal of fish in the water body. The setting device is configured for freely detachably mounting a fishing line. Further, the setting device is configured for manipulating the fishing line included with the boat. The manipulation of the fishing line includes at least one of releasing the fishing line into the water, raising the fishing line out of the water, and lowering the fishing into the water. The first receiver is configured for receiving the specific radio waves concerning the operations of at least one of the fish shoal detector, the propelling power source, the setting device, and the controller inducing the operations.

In an embodiment, a remote-control device for use with the remote controlled unmanned fishing boat includes a second transmitter, an operating signal emitter, a second receiver, a monitor, and a third receiver. The second transmitter is configured for transmitting specific radio waves concerning the operations of at least one of the fish shoal detector, the propelling power source, the controller, and the setting device to the first receiver. The operating signal emitter is configured for emitting the operating signals concerning at least one of the fish shoal detector, the propelling power source, the controller, and the setting device to the second transmitter. The second receiver is configured for receiving the specific radio waves carrying the information transmitted from the first transmitter. The monitor is configured for displaying position of the shoal of fish based on the signals received by the second receiver. The third receiver is configured for receiving specific radio waves carrying the information transmitted from the location tracker.

In an embodiment, the remote controlled unmanned fishing boat is further provided with an indicating lamp for visually informing an operator of the position of the remote controlled unmanned fishing boat. In an embodiment, the remote controlled unmanned fishing boat is a Catamaran and the location tracker is a Global Positioning System (GPS) tracker. In an embodiment, the remote controlled unmanned fishing boat is further provided with a lifting handle for lifting the boat from the water surface. The lifting handle may be formed from a cutout portion of the boat.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 shows a top perspective view of a remote controlled unmanned fishing boat, in accordance with an embodiment of the present invention;

FIG. 2 shows a top view of the remote controlled unmanned fishing boat, in accordance with an embodiment of the present invention;

FIG. 3 shows a bottom view of the remote controlled unmanned fishing boat, in accordance with an embodiment of the present invention;

FIG. 4 shows a rear view of the remote controlled unmanned fishing boat, in accordance with an embodiment of the present invention;

FIG. 5 shows a side view of the remote controlled unmanned fishing boat, in accordance with an embodiment of the present invention;

FIG. 6 shows an exemplary scenario where the remote controlled unmanned fishing boat is shown experiencing rolling waves on a surface of a water, in accordance with an embodiment of the present invention;

FIG. 7 illustrates a block diagram of the remote controlled unmanned fishing boat, in accordance with an embodiment of the present invention; and

FIG. 8 illustrates a block diagram of a remote-control device for use with the remote controlled unmanned fishing boat, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a remote controlled unmanned fishing boat. Accordingly, the components have been represented, showing only specific details that are pertinent for understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, the remote controlled unmanned fishing boat for using and performing remote control fishing in more efficiently and effectively manner Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems and methods have been described above, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The remote controlled unmanned fishing boat will now be described with reference to the accompanying drawings, which should be regarded as merely illustrative without restricting the scope and ambit of the present invention.

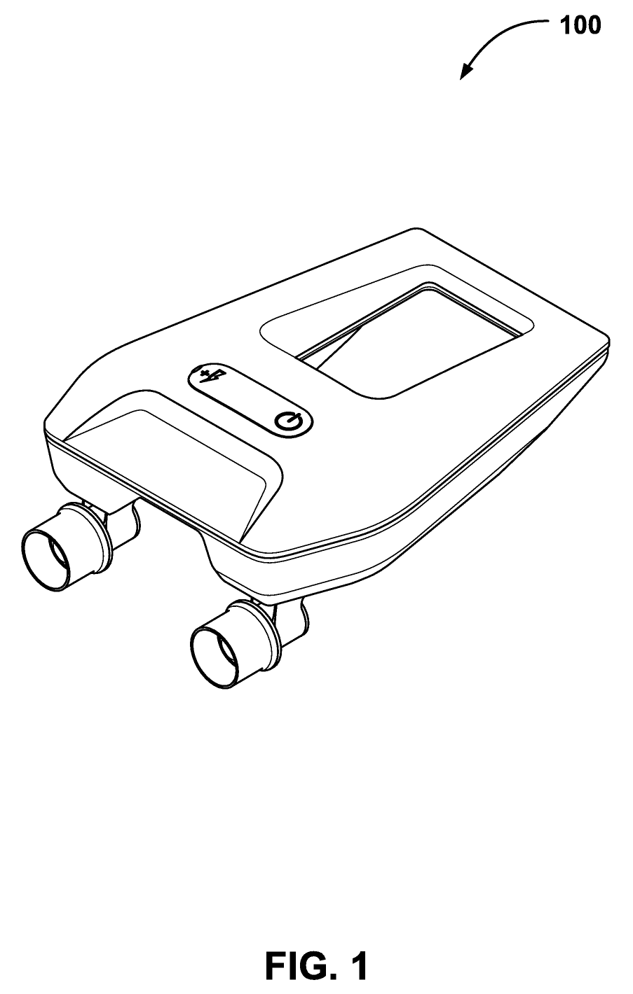

FIG. 1 shows a top perspective view of a remote controlled unmanned fishing boat 100, in accordance with an embodiment of the present invention. In an embodiment, the remote controlled unmanned fishing boat 100 is an unmanned fishing boat that can be used for remote control fishing in a water body such as a lake, a river, a channel, a bay, a pond, or the like. The remote controlled unmanned fishing boat 100 may be remotely controlled by an angler using a remote-control device that is continuously communicating with the remote controlled unmanned fishing boat 100. The remote controlled unmanned fishing boat 100 facilitates detection of a depth of water or a shoal of fish at a place that is far from the angler. Further, the angler can arbitrary change the place of detection by using the remote-control device. Further, the remote controlled unmanned fishing boat 100 enables the angler to drop his fishing line at an optimum position. Such dropping of the fishing line at the optimum position may be controlled and processed using the remote-control device by the angler. In an exemplary embodiment, the remote controlled unmanned fishing boat 100 is a Catamaran. In another exemplary embodiment, the remote controlled unmanned fishing boat 100 is a trimaran. In another exemplary embodiment, the remote controlled unmanned fishing boat 100 is a Small Waterplane Area Twin Hull (SWATH) boat.

In an embodiment, the remote controlled unmanned fishing boat 100 may be configured to carry a fishing line out and drop it at a location chosen by a user. The remote controlled unmanned fishing boat 100 may be remotely operated by the user (i.e., the angler) by means of the remote-control device that is communicatively synchronized with the remote controlled unmanned fishing boat 100. Examples of the remote-control device include, but are not limited to, a cell phone, a smart phone, a cellular phone, a cellular mobile phone, a personal digital assistant (PDA), a wireless communication terminal, a laptop, a personal computer, a Radio Frequency (RF) terminal, and a tablet computer. In an exemplary embodiment, various operations associated with the remote fishing may be controlled or executed by the user by means of a service application that is running on the remote-control device. In another exemplary embodiment, various operations associated with the remote fishing may be controlled or executed by the user by means of one or more selectable buttons that are provided on the remote-control device. For example, the user can operate the remote-control device to advance the remote controlled unmanned fishing boat 100 forward and backward and change the direction of the advance of the remote controlled unmanned fishing boat 100.

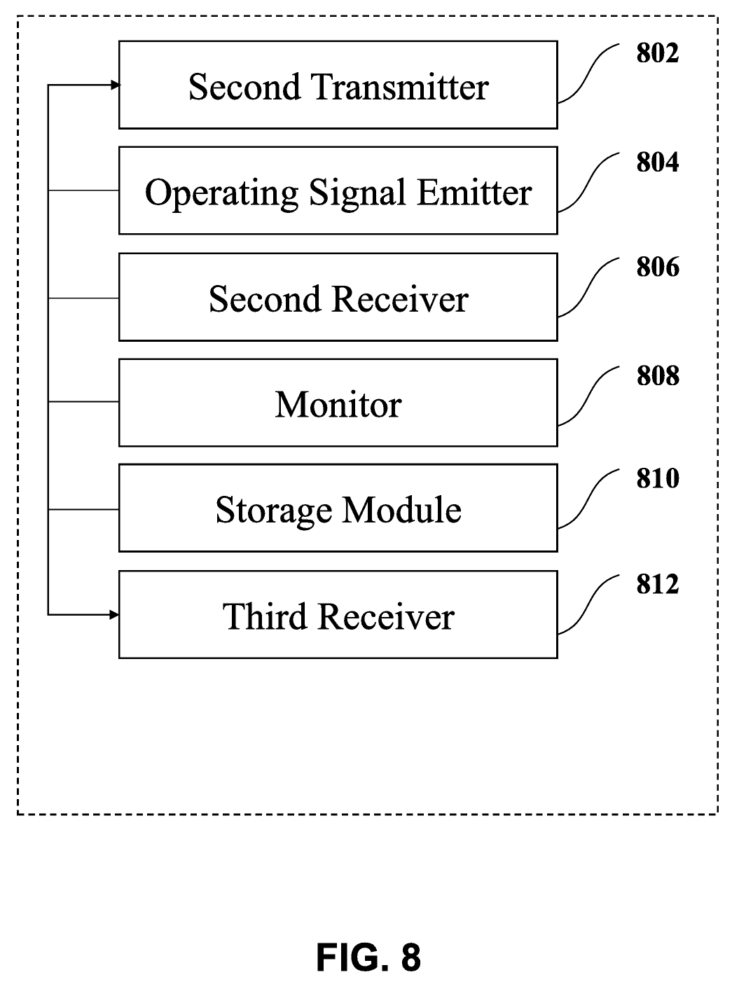

In an embodiment, the remote-control device may communicate with the remote controlled unmanned fishing boat 100 over a radio network. In an exemplary embodiment, the radio network includes a wired network. In another exemplary embodiment, the radio network includes a wireless network. Examples of types of the radio network include, but are not limited to, a local area network, a wide area network, a radio network, a virtual private network, an internet area network, a metropolitan area network, a satellite network, a Wi-Fi network, Bluetooth Low energy, a wireless network, and a telecommunication network. Examples of the telecommunication network include, but are not limited to, a global system for mobile communication (GSM) network, a general packet radio service (GPRS) network, third Generation Partnership Project (3GPP), an enhanced data GSM environment (EDGE) and a Universal Mobile Telecommunications System (UMTS). In an embodiment, the remote controlled unmanned fishing boat 100 includes at least one Radio Frequency (RF) transceiver. The RF transceiver may be used to transmit and/or receive radio signals between the remote controlled unmanned fishing boat 100 and the radio-control device. The radio control device has been described in detail in conjunction with FIG. 8.

In an embodiment, the remote controlled unmanned fishing boat 100 is a completely sealed boat. This makes manufacturing simpler since it becomes unnecessary to make seals for a removable battery. In an embodiment, the remote controlled unmanned fishing boat 100 may also include one or more locating light emitting diodes (LEDs) on its top surface. The one or more LEDs may be configured to emit lights such as red and green to allow the user to distinguish between the front and back of the remote controlled unmanned fishing boat 100, as viewed from a distance, for example, from the current location of the user. For a green light may indicate the front of the remote controlled unmanned fishing boat 100 and a red light may indicate the back of the remote controlled unmanned fishing boat 100. In an embodiment, the remote controlled unmanned fishing boat 100 is further provided with an indicating lamp for visually informing the user of the position of the remote controlled unmanned fishing boat 100.

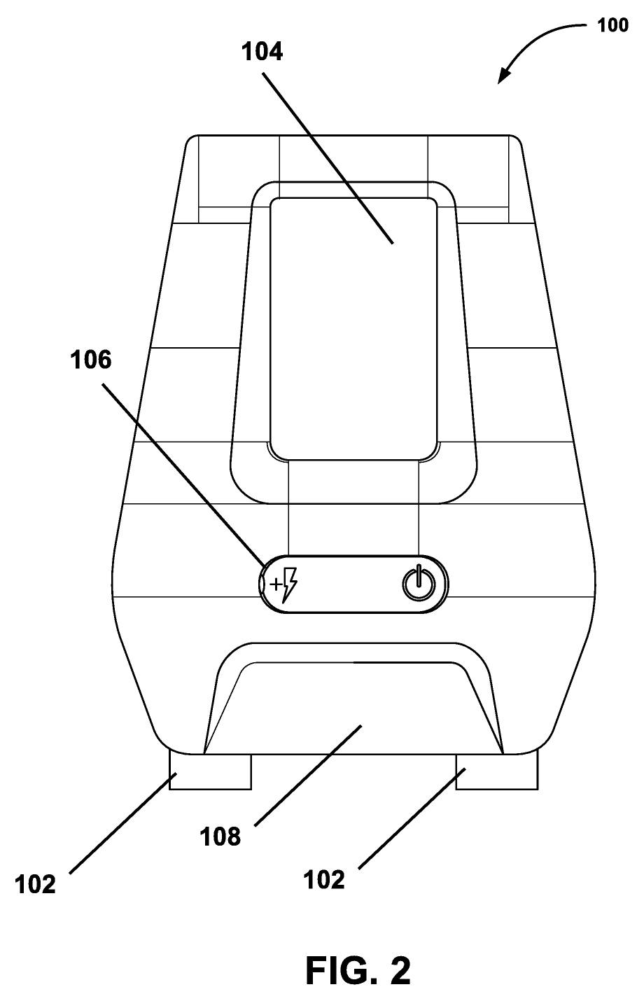

FIG. 2 shows a top view of the remote controlled unmanned fishing boat 100, in accordance with an embodiment of the present invention. In an embodiment, the remote controlled unmanned fishing boat 100 (herein after referred as “the boat 100”) includes a boat propulsion system 102, a cutout portion 104, a propelling power source 106, and a rear portion 108.

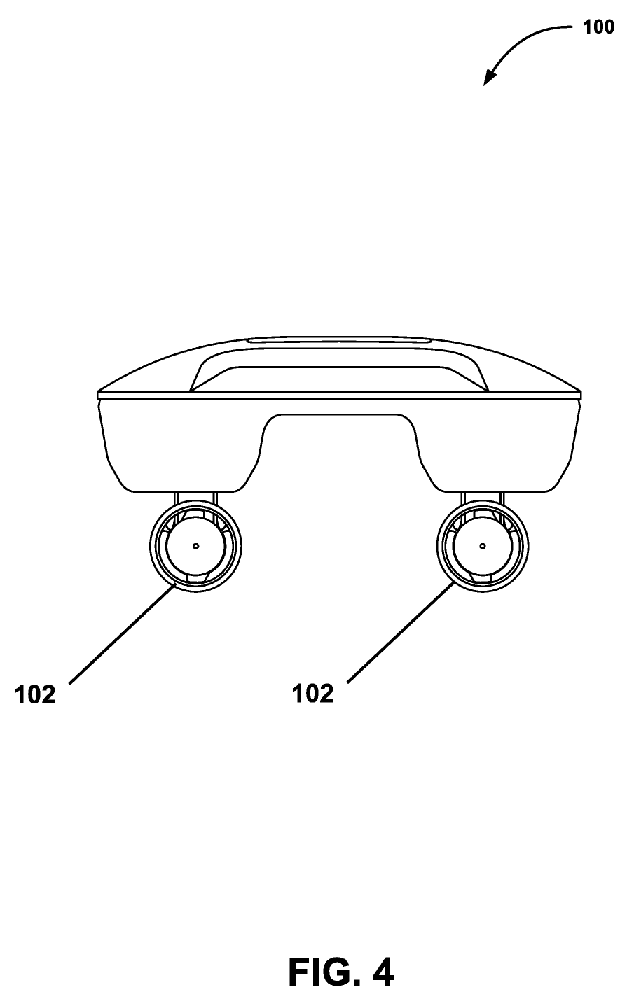

In an embodiment, the boat propulsion system 102 is a system that is used for moving the boat 100 in the water. For example, the boat propulsion system 102 may include a mechanical system or mechanism that is activated or operated to generate thrust to move the boat 100 across water. The boat 100 may be propelled by the mechanical system consisting of an electric motor or engine turning one or more propellers of the boat 100, thereby generating the thrust that drives the boat 100 across the water. For example, the boat 100 uses 2 motors. Steering works by giving more or less power to each motor. This configuration also works well for maneuvering in tight places and turning in small radii. The boat propulsion system 102 has been described in detail in conjunction with FIG. 4.

In an embodiment, the propelling power source 106 is a power source for propelling the boat 100. The propelling power source 106 may be composed of a rechargeable battery disposed in central part of the boat 100. Examples of types of battery include, but are not limited to, a lead—acid battery, a Nickel—Cadmium (NiCd) battery, a Nickel—Metal Hydride (NiMH) battery, a Lithium-ion (Li-ion) battery, and a Lithium-ion polymer (Li-ion polymer) battery. The battery is charged by the use of commercial power source. In an embodiment, the battery is charged through Universal Serial Bus (USB) based charging. In another example, the propelling power source 106 may be composed of an electric generator that is disposed in central part of the boat 100.

In an embodiment, the propelling power source 106 may be operated (i.e., turned ON or OFF) using a power button. The user can power ON the boat 100 or power OFF the boat 100 by pressing or tapping the power button that is provided on the boat 100 as shown in FIG. 2. The power button may be a soft switch or a mechanical switch. Further, the power button may also be remotely operated by the user over the network. By turning ON the power button, the propelling power source 106 is turned ON. When the propelling power source 106 is turned ON, the boat propulsion system 102 starts operating, thereby generating the appropriate thrush that is required for moving the boat 100 across the water. The propelling power source 106 may also include a charge port that is used for charging the battery disposed in central part of the boat 100. The charge port may be under a rubber cover. The power button may be recessed to avoid unintended power cycle.

In an embodiment, the propelling power source 106 is operationally connected to a battery information transmitting module (not shown) for transmitting the information concerning the residue of charge of the battery based on the detected voltage of the battery to the remote-control device. In an embodiment, the remote-control device includes a battery information receiving module for receiving the information transmitted from the battery information transmitting device concerning the residue of charge of the battery. Further, the remote-control device includes a display module for displaying thereon the residue of charge of the battery based on the information concerning the residue of charge of the battery. Furthermore, the remote-control device includes an alarm module for issuing an alarm based on the information concerning the residue of charge of the battery. For example, If, in case, the residue of the charge is less than a fixed standard amount, then the alarm module issues an alarm at the same time. The user is enabled to confirm visually the residue of the charge of the battery because the information concerning the residue of the charge of the battery can be received and displayed on the display device. Further, the user is warned of the approach of the exhaustion of the charge of the battery by sounding the alarm based on the detected residue of the charge of the battery.

Further, the boat 100 includes a setting device at the rear portion 108 of the boat 100 for freely detachably mounting a fishing line. Further, the setting device is configured for manipulating the fishing line. The manipulation of the fishing line may include at least one of releasing the fishing line into the water, raising the fishing line out of the water, and lowering the fishing into the water. In an embodiment, the setting device may be adapted to be operated by a radio transmitter-receiver. The radio transmitter-receiver is further capable of enabling to detect the catch of fish on the fishing line of the setting device and transmitting the information of this catch to the user. In an embodiment, the setting device includes a magnet. In an embodiment, the fishing line or tackle release mechanism is mechanical or magnetic. The magnet is embedded under the rear portion 108. The magnet may be used to clip a fishing hook. The fishing hook may be attached to the fishing line and is used for catching fish in the water body. The fishing line may be a cord that is made for fishing. Important parameters of the fishing line are its length, material, and weight (thicker, sturdier lines are more visible to fish). Various factors that may determine what line the user chooses for a given fishing environment may include breaking strength, knot strength, UV resistance, limpness, stretch, abrasion resistance, and visibility.

Further, the boat 100 includes a lifting handle for lifting the boat 100 from the water surface. The lifting handle is formed from the cutout portion 104 of the boat 100. The cutout portion 104 may server as a carrying handle as well as a grappling location for retrieving the boat 100 from the water. Additionally the boat 100 is sized small enough to use a fishing net to pull out the boat 100 from the water. In an embodiment, the boat 100 also includes a bug attractant that is meant for attracting the bugs and/or fish. In an embodiment, the boat 100 further includes a floodlight, a running light, a sonar module, GPS sensors, an infrared camera, an auxiliary camera, a depth finder, a metal detector, a fish finder, and a temperature sensor.

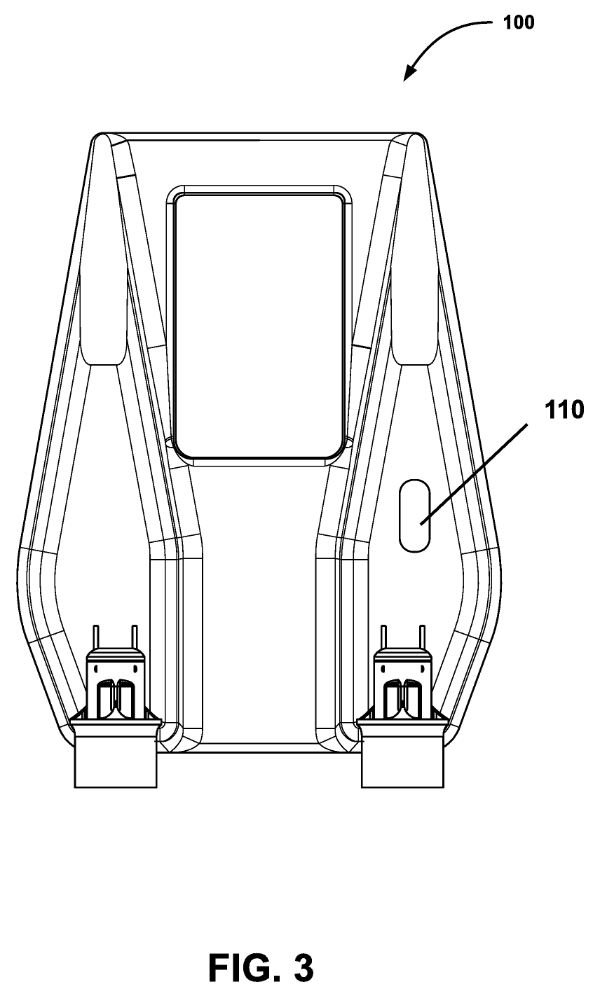

FIG. 3 shows a bottom view of the remote controlled unmanned fishing boat 100, in accordance with an embodiment of the present invention. As shown, the boat 100 includes a fish shoal detector 110 for detecting a shoal of fish. The fish shoal detector 110 eliminates the water surface glare and allows viewing as far as water clarity and light permit. In an embodiment, the fish shoal detector 110 includes a downfaced underwater camera. In an embodiment, the camera includes a modified transducer body with a self-contained miniaturized camera available for coupling to a monitor (shown in FIG. 8) in a safe and protected location. In an embodiment, the camera is a Thru-hull video camera. The camera can be mounted within a hull of the boat 100 or can be a waterproof camera mounted outside the hull or enclosed in a waterproof casing outside of the hull. More than one camera can be positioned at multiple different locations on the boat 100 to give multiple views. Alternatively, the camera can be mounted on a moving stage that rotates and moves up and down, so as to obtain numerous different views from a single camera. In addition to seeing fish, another advantage of the camera is that it allows the user to see places (e.g., places include sunken trees, vegetation, and the like) that fish will likely be at a later time. For example, in fishing tournaments, the competitors often go to the lake before the competition and try to find the best places for fishing later. In an embodiment, the operation of the camera may be remotely controlled by the user using the remote-control device over the network.

In an embodiment, the camera is operationally coupled to a stabilization module (either integrated with the boat 100, the remote-control device, or the camera itself) to minimize motion disturbances in a captured image or video frame, wherein the motion disturbances arise due to camera movement. In an embodiment, the stabilization module achieves elimination of the motion disturbances in the captured image or video frame by varying the optical path of the image as it travels to the sensor or putting the camera on a gimbal and moving the camera in such a way as to counteract motion disturbances in the resulting image. In another embodiment, the stabilization module achieves elimination of the motion disturbances in the captured image or video frame by using image stabilization logic to shift subsequent frames in such a way as to minimize the effects of camera movement. For example, active (mechanical) stabilization may be achieved by varying the optical path of the image as it travels to the sensor or putting the camera on a gimbal and moving the camera in such a way as to counteract motion disturbances in the resulting image. In an embodiment, the image stabilization is also done in software on the monitor instead of on the boat 100. For example, digital stabilization may be achieved by using an image stabilization computer algorithm to shift subsequent frames in such a way as to minimize the effects of camera movement.

The boat 100 can be operated at will by transmitting relevant specific radio waves from the remote-control device. Using the monitor which is capable of displaying the position of the shoal of fish, the user is enabled to find the optimum position for fishing and lower his fishhook to attain effective fishing.

FIG. 4 shows a rear view of the remote controlled unmanned fishing boat 100, in accordance with an embodiment of the present invention. As shown, the rear view of the boat 100 includes the boat propulsion system 102. The boat propulsion system 102 includes the one or more propellers. Such propulsion system is associated, in general, with watercraft which are intended for traveling in the water. Such watercraft have a bottom, at least parts of which are flat, and one or more vertical propeller steering shafts which connect one or more motor (for example, 2 motors) engines in the interior of the boat 100 to the one or more propellers. The one or more propellers may cause propulsion of the watercraft by rotation around its horizontal axis.

Various types of the boat propulsion system 102 may include sterndrive (inboard/outboard drive), inboard motors, and outboard motors. The inboard propulsion systems have their engines mounted inside the hull of the boat 100, usually in the center. A motor drive unit such as driveshaft runs from the motor engine to the outside of the boat 100 where it connects to the one or more propellers. An inboard boat has a rudder mounted directly behind the one or more propellers to enable steering of the boat 100. The outboard propulsion systems have the motor drive unit mounted externally to the rear of the boat 100 that contains the engine, gearbox, and the one or more propellers. These are the most common propulsion systems for boats. Not only does the unit provide propulsion, it also provides steering control all in one. The sterndrive propulsion systems have the motor drive unit that is mounted to the rear of the boat 100 with the engine sitting just forward of the transom, or rear of the boat 100. The outdrive delivers power from the engine to the one or more propellers. The bottom half of the outdrive has a slight resemblance to an outboard motor. The motor drive unit of the boat 100 will be injection molded plastic and should probably be a solid color.

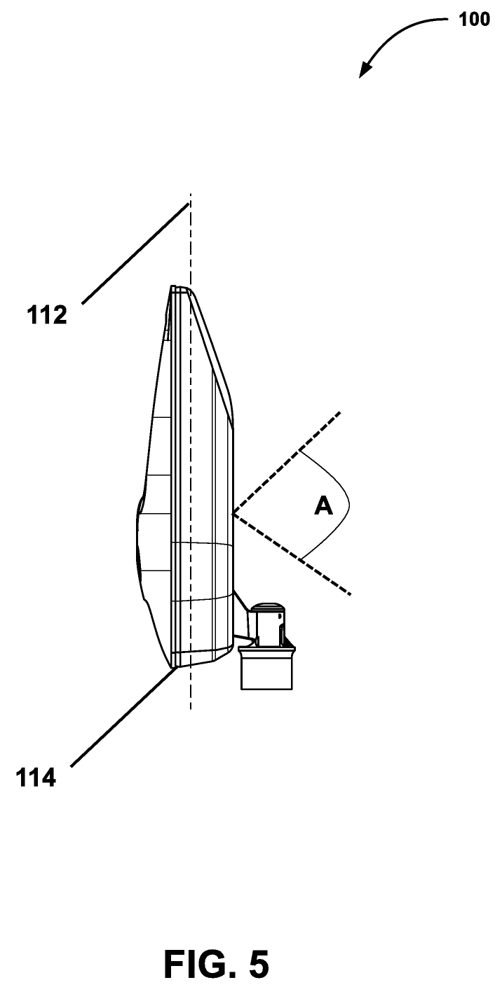

FIG. 5 shows a side view of the remote controlled unmanned fishing boat 100, in accordance with an embodiment of the present invention. As shown, a parting line 114 between superstructure of the boat 100 and the hull of the boat 100 is covered with tape. The line where the hull of the boat 100 meets the surface of the water is shown as a waterline 112. Approximate viewing angle of the camera of the fish shoal detector 110 is denoted by “A”.

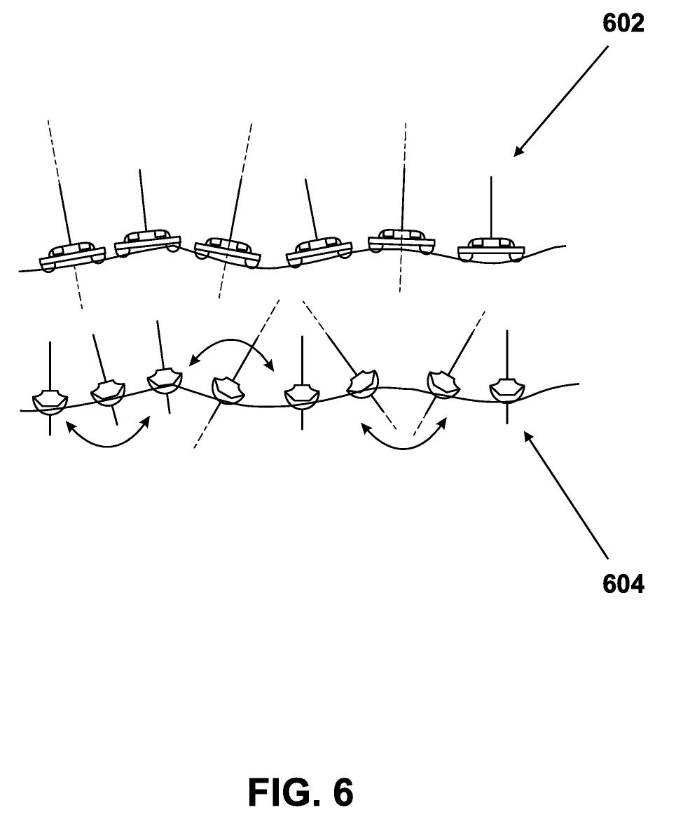

FIG. 6 shows an exemplary scenario where the remote controlled unmanned fishing boat 100 is shown experiencing rolling waves on a surface of a water, in accordance with an embodiment of the present invention. Roll behavior of monohulls is different than that of catamarans. As shown, waves may be traveling from left to right, and there the multihull strictly conforms to the slopes 202, whereas the ballasted monohull starts a self-excited roll cycle 204, heeling the boat 100 far beyond the angle of the wave face. As the boat 100 includes multiple hulls, the movement of the boat 100 offers more stability as compared to mono hulls. Strategies to reduce camera movement due to waves includes keeping the center of gravity low and the moment of inertia high. This combination tends to be stable and reject low frequency disturbances, and using a multi-hull instead of a single hull. This gives the boat 100 a wider stance that eliminates much of the tendency to rolling that a single hull exhibits. The boat 100 uses a small waterline area hull to reduce wave forces.

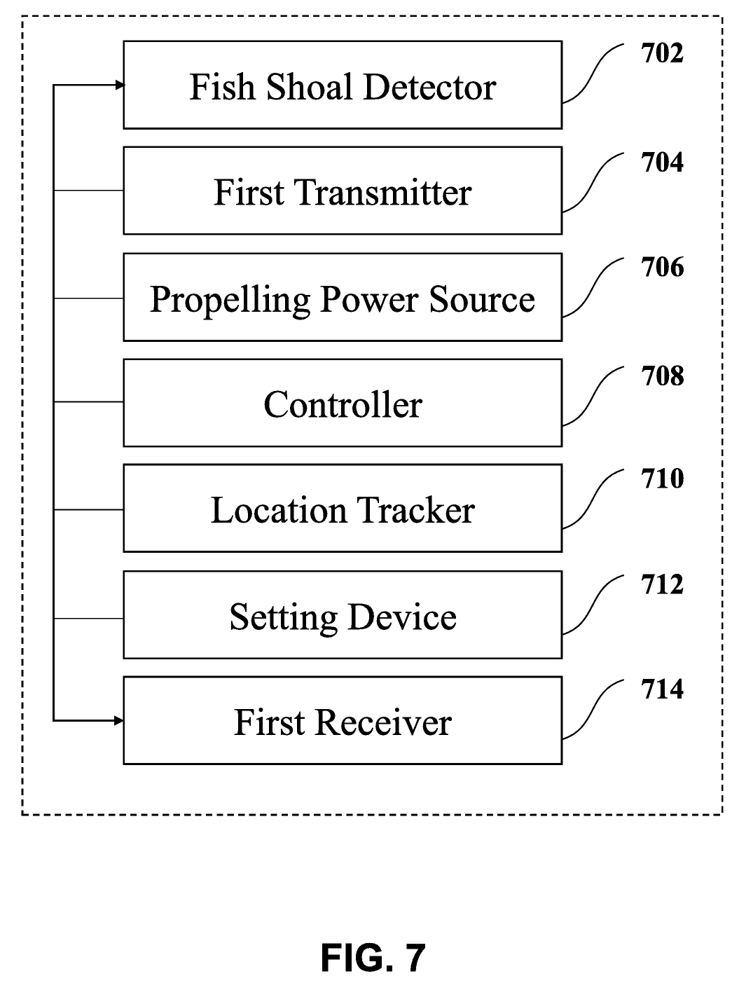

FIG. 7 illustrates a block diagram of various circuitry of the remote controlled unmanned fishing boat 100, in accordance with an embodiment of the present invention. In an embodiment, the boat 100 includes a fish shoal detector 702 (such as the fish shoal detector 110), a first transmitter 704, a propelling power source 706 (such as the propelling power source 106), a controller 708, a location tracker 710, a setting device 712, and a first receiver 714. The fish shoal detector 702 is configured to detect the shoal of fish. The first transmitter 704 is configured to transmit, by specific radio waves, the information concerning the shoal of fish detected by the fish shoal detector 702 to the remote-control device that is present with the user. The propelling power source 706 is configured to propel the boat 100. The controller 708 is configured to steer the boat 100. The user gives operational commands by means of the remote-control device (e.g., mobile phone or a dedicated remote control) to the controller 708 for steering the boat 100. The location tracker 710 is configured to transmit the location coordinate of the boat 100 to the remote-control device. The user can also trace the lost boat 100 from the location coordinate of the boat 100. The setting device 712 is configured to freely detach the fishing line after receiving any operational command from the user. Further, the setting device 712 may be configured for manipulating the fishing line included with the boat 100. The manipulation of the fishing line includes at least one of releasing the fishing line, raising the fishing line, and lowering the fishing. The first receiver 714 is configured to receive the specific radio waves concerning the operations of at least one of the fish shoal detector 702, the propelling power source 706, the setting device 712, and the controller 708, and induce the respective operations. In an embodiment, the controller 708 facilitates a go home functionality (i.e., the boat 100 returns to the location of the user or a designated area after some action, such as releasing the bait).

FIG. 8 illustrates a block diagram of a remote-control device for use with the remote controlled unmanned fishing boat 100, in accordance with an embodiment of the present invention. In an embodiment, the remote-control device includes a second transmitter 802, an operating signal emitter 804, a second receiver 806, a monitor 808, a storage module 810, and a third receiver 812. The second transmitter 802 is configured to transmit specific radio waves concerning the operations of at least one of the fish shoal detector 702, the propelling power source 706, the controller 708, and the setting device 712 to the first receiver 714. The operating signal emitter 804 is configured to emit to the second transmitter 802 the operating signals concerning at least one of the fish shoal detector 702, the propelling power source 706, the controller 708, and the setting device 712. The second receiver 806 is configured to receive the specific radio waves carrying the information transmitted from the first transmitter 704. The monitor 808 is configured to display position of the shoal of fish based on the signals received by the second receiver 806. The monitor 808 is also configured to display the position of the boat 100. The third receiver 812 is configured to receive the specific radio waves carrying the information transmitted from the location tracker 710. The storage module 810 is configured to store data related to the location of the boat 100 and the location of the shoal of fish. In an embodiment, the storage module 810 is a multi-tier storage system. In another embodiment, the storage module 810 may store the information in an encrypted format. In yet another embodiment, the storage module 810 may store the information in an indexed format. The storage module 810 facilitates storage, retrieval, modification, and deletion of data in conjunction with various data-processing operations. Storage module information may be retrieved through queries using keywords and sorting commands, in order to rapidly search, rearrange, group, and select the field.

Although particular embodiments of the invention have been described in detail for purposes of illustration, various modifications and enhancements may be made without departing from the spirit and scope of the invention. Further, various embodiments of the present invention, as described above, illustrate the boat 100 as an unmanned fishing boat that can be used by the user for remote control fishing in the water. However, the application of the boat 100 is not limited to only fishing. In various other applications, the boat 100 may be intended to be used as a remotely operated boat camera. The users may utilize the remotely operated boat camera to explore underwater areas. Further, the users may utilize the remotely operated boat camera to inspect things such as a pool or a tank of water. Further, the users may utilize the remotely operated boat camera for searching underwater things like sunken ships.

What is claimed is:

1. A remote controlled unmanned fishing boat for remote control fishing, comprising:
a fish shoal detector for detecting a shoal of fish;
a first transmitter for transmitting information concerning the shoal of fish detected by the fish shoal detector to a remote-control device present with a user who is away from the boat;
a propelling power source for propelling the boat;
a controller for steering the boat; and
a first receiver for receiving, from the remote-control device, specific radio waves concerning operations of at least one of the fish shoal detector, the propelling power source, and the controller, inducing the operations.

2. The remote controlled unmanned fishing boat of claim 1, further comprising, an indicating lamp for visually informing the user about a location of the boat in water.

3. The remote controlled unmanned fishing boat of claim 1, wherein the boat is further provided with a lifting handle for lifting the boat from water surface, wherein the lifting handle is formed from a cutout portion of the boat.

4. The remote controlled unmanned fishing boat of claim 1, wherein the boat is communicatively connected to the remote-control device over a network.

5. The remote controlled unmanned fishing boat of claim 1, further comprising a downfaced underwater camera that is mounted within a hull of the boat.

6. The remote controlled unmanned fishing boat of claim 5, wherein the camera is a Thru-hull video camera.

7. The remote controlled unmanned fishing boat of claim 5, wherein the camera includes a modified transducer body with a self-contained miniaturized camera available for coupling to a monitor of the remote-control device over a network.

8. The remote controlled unmanned fishing boat of claim 7, wherein the camera is remotely controlled by the user using the remote-control device over the network.

9. The remote controlled unmanned fishing boat of claim 8, wherein the camera is coupled to a stabilization module to minimize motion disturbances in a captured image or video frame.

10. The remote controlled unmanned fishing boat of claim 9, wherein the stabilization module achieves elimination of the motion disturbances in the captured image or video frame by varying optical path of the image as it travels in water.

11. The remote controlled unmanned fishing boat of claim 9, wherein the stabilization module achieves elimination of the motion disturbances in the captured image or video frame by using image stabilization logic to shift subsequent frames in such a way so as to minimize effects of camera movement.

12. The remote controlled unmanned fishing boat of claim 1, further comprising, one or more locating light emitting diodes (LEDs) on its top surface.

13. The remote controlled unmanned fishing boat of claim 1, wherein the one or more LEDs are configured to emit lights to allow the user to distinguish between front and back of the remote controlled unmanned fishing boat, as viewed from a location of the user, wherein the location of the user is different from a location of the boat.

14. The remote controlled unmanned fishing boat of claim 1, further comprising, a power button on its top surface, wherein the power button is used by the user to turn ON or turn OFF the propelling power source.

15. The remote controlled unmanned fishing boat of claim 14, wherein the power button is remotely controlled by the user using the remote-control device.

16. The remote controlled unmanned fishing boat of claim 1, further comprising, a magnet that is embedded under a rear portion of the boat, wherein the magnet is used to clip a fishing hook.

17. The remote controlled unmanned fishing boat of claim 1, further comprising a location tracker for transmitting location coordinate of the boat to the remote-control device over a network, wherein the location tracker is a Global Positioning System (GPS) tracker.

18. The remote controlled unmanned fishing boat of claim 17, wherein the remote-control device comprises:
a second transmitter for transmitting specific radio waves concerning the operations of at least one of the fish shoal detector, the propelling power source, and the controller, to the first receiver;
an operating signal emitter for emitting to the second transmitter the operating signals concerning at least one of the fish shoal detector, the propelling power source, and the controller;
a second receiver for receiving specific radio waves carrying the information transmitted from the first transmitter;
a monitor for displaying position of the shoal of fish based on the signals received by the second receiver; and
a third receiver for receiving specific radio waves carrying the information transmitted from the location tracker.

19. The remote controlled unmanned fishing boat of claim 1, further comprising a setting device for manipulating a fishing line included with the boat.

20. The remote controlled unmanned fishing boat of claim 19, wherein the manipulation of the fishing line includes at least one of releasing the fishing line into water, raising the fishing line out of the water, and lowering the fishing into the water.
